(19) United States
(12) Patent Application Publication
(10) Pub. No.: US 2006/0110235 A1
(43) Pub. Date: May 25, 2006

(54) Fastening element for fastening an object to a receiving member

(76) Inventors: Hans-Joachim Dembowsky, Hamburg (DE); Alexander Vorderwisch, Bielefeld (DE); Martin Jodeleit, Bielefeld (DE)

Correspondence Address: SEYFARTH SHAW LLP, 55 E. MONROE STREET, SUITE 4200, CHICAGO, IL, 60603-5803, US

(21) Appl. No.: 11/270,054

(22) Filed: Nov. 9, 2005

(30) Foreign Application Priority Data
Nov. 24, 2004 (DE) 20 2004 018 224.6

(51) Int. Cl. F16B 21/00

(52) U.S. Cl. 411/349

(57) ABSTRACT

The fastening element includes a support plate. A fastening portion for retaining the object is provided on a first side of the support plate. An anchoring portion is provided on the opposite side of the support plate. The anchoring portion is insertable into an anchoring hole of the receiving member and adapted to penetrate into the material of the receiving member when the fastening element is rotated via a drive portion. A stop portion cooperates with the receiving member so as to limit rotation of the fastening element.

### BACKGROUND OF THE INVENTION

The present invention relates to a fastening element for fastening an object to a receiving member, in particular for fastening a cover sheet to a plastic shell of a vehicle seat.

Conventional fastening methods for fastening a cover sheet to a seat or back shell of a vehicle encompass plastic welding and mechanical threading. In the latter case recesses are formed in the seat or back shell during blow-moulding thereof; metallic threaded sleeves are thermally embedded into said recesses for fastening the seat covers. Each of the conventional fastening methods has its advantages and disadvantages; in any case, however, these methods are relatively costly.

### SUMMARY OF THE INVENTION

It is a primary object of the present invention to provide a fastening element for fastening an object to a receiving member, which fastening element may be manufactured in a cost-effective manner and may be assembled in an extremely simple manner.

The fastening element of the present invention has been defined in patent claim 1.

The fastening element comprises a support plate, a fastening portion provided on a first side of said support plate and adapted to retain said object, an anchoring portion provided on an opposite second side of said support plate, said anchoring portion being insertable into an anchoring hole of said receiving member and adapted to be anchored in the material of said receiving member by limited rotation of the fastening element, a drive portion for rotating the fastening element, and a stop portion cooperating with said receiving member to limit rotation of the fastening element.

The fastening element of the present invention may be manufactured from plastic material by injection moulding so as to form an integral one-piece member. As a result manufacturing costs are relatively low. Furthermore, the fastening element may be connected to the receiving member in an extremely simple manner because it is only necessary to insert the anchoring portion into the anchoring hole of the receiving member and to rotate the fastening element for a limited amount. When the fastening element has been connected to the receiving member in this manner, the object to be fixed may be readily mounted to the fastening portion of the fastening element.

The fastening element of the present invention is particularly suited for fastening a cover sheet to a plastic shell of a vehicle seat even though it may be used for fastening other objects to other receiving members.

Modifications and further developments of the present invention have been defined in the dependent claims.

### BRIEF DESCRIPTION OF THE DRAWINGS

These and other objects, features and advantages of the present invention will be apparent from the following detailed description of the preferred embodiment, appended claims and accompanying drawings in which:

FIG. 1 is a side-elevation of a fastening element according to the present invention;

FIG. 2 is side-elevation of the fastening element in FIG. 1 when rotated about 90°;

FIG. 3 is a bottom view of the fastening element in FIG. 1;

FIG. 4 is a top view of the fastening element in FIG. 1;

FIG. 5 is a sectional view of a small part of a receiving member for receiving the fastening element;

FIG. 6 is perspective view of the fastening element and the receiving member in a reduced scale.

### DETAILED DESCRIPTION OF THE PREFERRED EMBODIMENT

The fastening element 2 shown in FIGS. 1 to 4 is intended to fasten an object (not shown) to a receiving member 4 (FIG. 5). Preferably the object is a seat cover sheet, and the receiving member 4 is a seat shell or back shell of a vehicle seat. As shown in particular in FIG. 1, the fastening element 2 comprises a support plate 6, an anchoring portion 8, a drive portion 10, a fastening portion 12, and a stop portion 14.

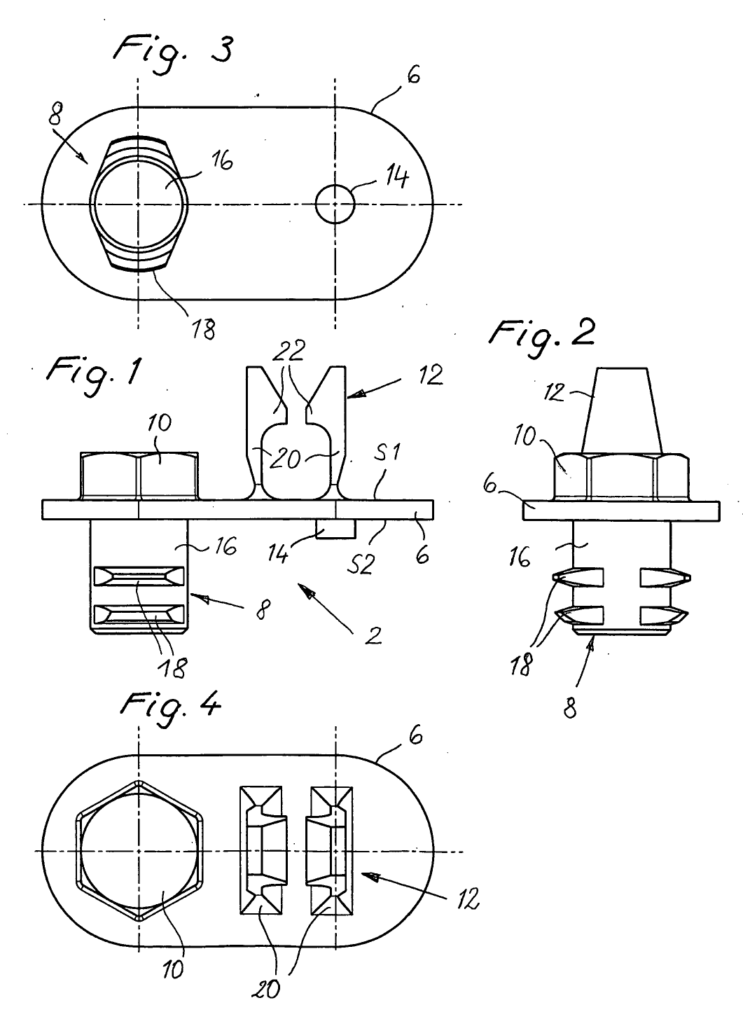

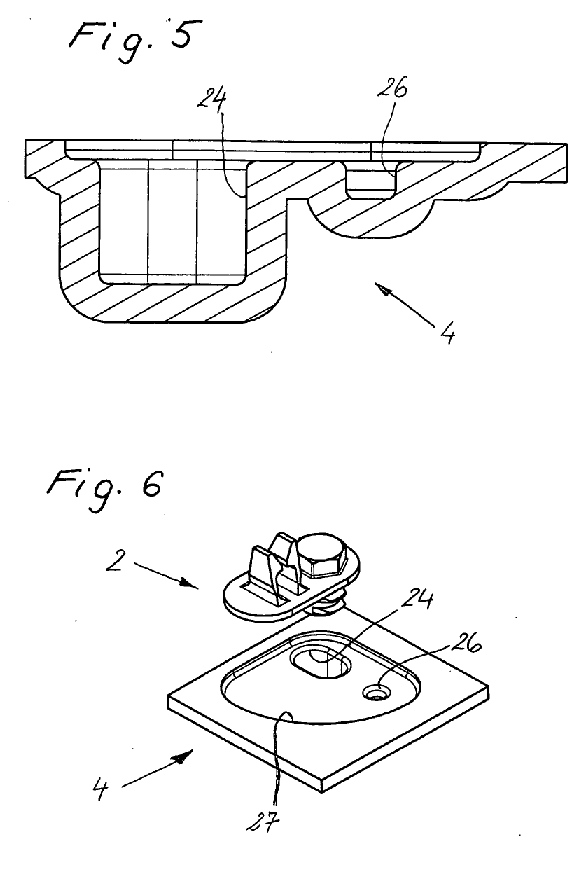

The support plate 6 is a planar member of small thickness and of an elongated shape as shown in particular in FIGS. 3, 4. The drive portion 10 and the fastening portion 12 integrally extend from a first side SI of the support plate 6, while the anchoring portion 8 and the stop portion 14 integrally extend from the opposite second side S2 of the support plate 6. The arrangement is such that the anchoring portion 8 and the drive portion 10 are aligned with respect to each other, i.e. they extend along a common axis which is perpendicular to the plane of the support plate 6. The fastening portion 12 is laterally offset with respect to the drive portion 10, and the stop portion 14 is laterally offset with respect to the anchoring portion 8.

The anchoring portion 8 is intended to connect the fastening element 2 to the receiving member 4. The anchoring portion 8 comprises a pin 16 integrally extending from the support plate 6, and a plurality of anchoring projections integrally projecting from the pin 16. In the embodiment as shown the anchoring projections comprise four ribs 18 extending circumferentially about the pin for less than the circumference of the pin. As shown in particular in FIG. 3, the ribs 18 extend about the pin for about 90°. The ribs 18 are arranged in pairs such that they are disposed in two axially offset rows, and in each row two ribs are diametrically opposite to each other.

The ribs 18 have radially external tapered edges. Furthermore, they have circumferential ends which are tapered such that the two circumferential ends of each rib 18 include an angle of about 45° as is readily apparent from FIG. 3.

In the embodiment as shown in FIG. 3, the pin 16 and the ribs 18 are of a common non-circular external contour, in particular an oval external contour. This external contour of the anchoring portion 8 is matingly shaped with respect to the smooth receiving hole 24 of the receiving member 4 (cf. FIGS. 5 and 6) such that the anchoring portion 8 may be readily inserted into the anchoring hole 24 of the receiving member when the fastening element 2 is in a predetermined position in alignment to the receiving member 4. The fastening element 2 may be anchored within the anchoring hole 24 by being rotated for a certain amount as will be explained in more detail below.

In the embodiment as shown the drive portion 10 is a hexagonal portion for being engaged by a respective tool (not shown) so as to rotate the fastening element 2 about an axis extending through the drive portion 10 and the anchoring portion 8. It should be noted, however, that the drive portion 10 may be of any other type for being engaged by a respective tool.

In the embodiment as shown, the fastening portion 12 comprises a retaining clip for retaining the respective object (seat cover sheet; not shown). The retaining clip comprises a pair of resilient arms 20 extending from the support plate 6 and provided with hooks 22 facing each other for engaging the seat cover sheet as is readily apparent from FIGS. 1 and 4.

The stop portion 14 comprises a cylindrical snap-in projection which cooperates with a matingly shaped recess 26 in the receiving member 4 so as to fix the fastening element 2 at the receiving member 4 in a predetermined position and orientation as will be explained in more detail below.

The fastening element 2 is an integral one-piece member which is made from plastic material by injection moulding. The plastic material preferably is a fibre-reinforced, impact resistant plastic material such as a polyamide having a high glass fibre content. The material may be for example PA6-GF50. In each case the material of the fastening element 2 is of a hardness exceeding that of the material of the receiving member 4 which may be made e.g. from a relatively soft plastic material such as ABS/PC by blow-moulding.

Mounting of the fastening element 2 to the receiving member 4 will now be described with reference in particular to FIG. 6.

Initially the fastening element 2 is positioned with respect to the receiving member 4 such that the anchoring portion 8 may enter into the anchoring hole 24 of the receiving member 4. A flat depression 27 surrounding the anchoring hole 24 and the recess 26 facilitates aligning and inserting the fastening element 2. The anchoring portion 8 is pushed into the anchoring hole 24 so that the support plate 6 will engage the receiving member 4. As mentioned above the smooth receiving hole 24 is of an oval internal contour matingly shaped with respect to the oval external contour of the anchoring portion 8 such that the anchoring portion 8 may be inserted into the anchoring hole 24 of the receiving member 4 only when in a predetermined orientation. When in this orientation the stop portion 14 of the fastening element 2 is displaced with respect to the recess 26 of the receiving member 4 for approximately 90°.

When the support plate 6 is in this position, it is under a certain bias because the stop projection 14 lies upon the top surface of the receiving member 4 such that the support plate 6 is slightly deflected. When the fastening element 2 is rotated about the axis of the drive portion 10 and the anchoring portion 8 by a tool (not shown) in engagement with the drive portion 10, the tapering ribs 18 of the anchoring portion 8 penetrate into the softer material of the receiving member 4. As a result the anchoring portion 8 and the receiving member 4 are positively interlocked.

At the end of the 90° rotation of the receiving member 2, the snap-in projection 4 snaps into the recess 26 of the receiving member 4. This defines the end of the rotation and therefore the end position of the fastening element 2, and furthermore ensures a predetermined geometrical orientation of the fastening element 2 such that the fastening portion 12 is in a predetermined position and orientation with respect to the receiving member 4.

As a result the fastening element 2 is fixedly connected to the receiving member 4 in a predetermined position and in a predetermined orientation such that the respective object (seat cover sheet) may be fixed to the fastening portion 12.

We claim:

1. A fastening element for fastening an object to a receiving member, comprising:
a support plate,
a fastening portion provided on a first side of said support plate and adapted to retain said object,
an anchoring portion provided on an opposite second side of said support plate, said anchoring portion being insertable into an anchoring hole of said receiving member and adapted to be anchored in the material of said receiving member by limited rotation of the fastening element,
a drive portion for rotating the fastening element, and
a stop portion cooperating with said receiving member to limit rotation of the fastening element.

2. A fastening element as defined in claim 1 wherein said drive portion and said anchoring portion are disposed on opposite sides of the support plate so as to be aligned with respect to each other.

3. A fastening element as defined in claim 2 wherein said drive portion is disposed on said first side of said support plate so as to be laterally offset with respect to said fastening portion.

4. A fastening element as defined in claim 1 wherein said stop portion is provided on said second side of said support plate so as to be laterally offset with respect to said anchoring portion.

5. A fastening element as defmed in claim 1 wherein said anchoring portion comprises a pin and a plurality of anchoring projections projecting from said pin, said pin and said anchoring portions being of a common, non-circular external contour matingly shaped with respect to an internal contour of the receiving hole of said receiving member such that said anchoring projections penetrate into the material of said receiving member during said limited rotation of said fastening element.

6. A fastening element as defined in claim 5 wherein said external contour of said anchoring portion of said fastening element and the internal contour of said anchoring hole of said receiving member are of an oval shape.

7. A fastening element as defined in claim 5 wherein said anchoring projections comprise ribs having tapered external ends, said ribs extending circumferentially with respect to said pin about less than the total circumference of said pin.

8. A fastening element as defined in claim 1 wherein said stop portion of the fastening element comprises a snap-in projection provided at said support plate and adapted to snap into a recess of said receiving member at the end of said limited rotation of the fastening element.

9. A fastening element as defined in claim 1 wherein said fastening portion comprises a retaining clip for retaining said object.

10. A fastening element as defined in claim 9 wherein said retaining clip comprises a pair of resilient arms projecting from said support plate and including hooks directed towards each other for retaining said object.

11. A fastening element as defined in claim 1, which is an integral one-piece part made of plastic material by injection moulding.

12. A fastening element as defined in claim 11, which is made of a fibre reinforced, impact resistant plastic material.

13. A fastening element as defined in claim 1 and adapted to fasten a cover to a plastic shell of a vehicle seat.
